(19) United States
(12) Patent Application Publication
(10) Pub. No.: US 2017/0093276 A1
(43) Pub. Date: Mar. 30, 2017

(54) Voltage Transient Improvement Using Zero Crossing Detectors of Master and/or Slave Phase Inductors of a DC-DC Converter

(71) Applicant: Apple Inc., Cupertino, CA (US)

(72) Inventors: Rajarshi Paul, Cupertino, CA (US); Parin Patel, San Francisco, CA (US)

(21) Appl. No.: 14/871,062

(22) Filed: Sep. 30, 2015

(51) Int. Cl. H02M 3/04

(52) U.S. Cl. CPC H02M 3/04

(57) ABSTRACT

This disclosure relates to switch mode multiphase DC-DC voltage regulator circuits. In prior art regulators, for standard load transients, the worst voltage undershoot happens during a “zero to max,” i.e., “load step” operation. When the load is released, the inductor current ramps down, eventually crossing zero, where it is then held at a negative current limit (i.e., “NLIMIT”) by a Negative Current Limit Detector Circuit. However, if the next load step were to happen right at the instant when the inductor hits the negative current limit, it would take additional time recover to zero before it could catch up to the load step, thus causing additional voltage drop. Regulators disclosed herein comprise specialized zero crossing detection circuitry that intelligently prevents the inductor currents in one or more of the phases of the regulator from ramping below zero, thereby improving voltage droop in the system during fast positive load transients.

### BACKGROUND

This disclosure relates generally to switch mode multiphase DC-DC voltage regulator circuits used in portable consumer electronic devices. Other embodiments are also described herein.

Output voltage regulation and maintaining the accuracy of the regulated voltage provided by a switch mode power converter can be a very demanding task. For example, in the field of multi-function portable consumer electronic devices (also referred to herein as “mobile devices,” such as smartphones, tablet computers, and laptop computers), the power requirements of the constituent components such as the display screen, the wireless communications interface, the audio subsystem, and the system on a chip (SoC) or applications processor are quite demanding. For example, in such devices, the load on an output node of a voltage regulator can exhibit sudden changes that are so great, e.g., as fast as fast as 10 A/μs to 10 A/ns, that the output node may exhibit significant transient voltage drop.

Attempts at reducing the transient voltage drop by the conventional approach of simply using faster inductor slewing and larger capacity and higher performance decoupling and/or filter capacitors may not be practical in many instances.

For standard load transients, wherein the duty cycle of the positive edge of the step load is larger than the ramp down time of the inductors or the natural frequency of the system, the worst voltage undershoot happens during a “zero to max,” so-called “load step” operation with the fastest dI/dt of the load. When the load is released, the inductor current ramps down, eventually crossing zero, where it is then held at a negative current limit (i.e., “NLIMIT”) by a Negative Current Limit Detector Circuit. This has the purpose of protecting the low-side field-effect transistor (FET), as well as discharging the over-charged capacitor.

However, if the next load step were to happen right at the instant when the inductor hits the negative current limit, it would take an additional time to ramp up and recover to zero before it could catch up to the load step. This causes additional voltage droop with respect to standard “zero to max” load step operation with high duty cycle. This is explained in greater detail with reference to FIG. 3A below, where both the slave and master inductor currents ramp down to the negative current limit (i.e., substantially below 0 mA), and then a load step happens. Such problems are now increasingly seen with faster processor designs (e.g., multi-Gigahertz), and especially in processors with bursty load steps with occasional stalls and smaller duty cycles.

Thus, what is needed is an improved multiphase DC-DC voltage regulator that overcomes the various issues of the above-mentioned prior art systems and provides a solution that delivers higher efficiency and safety due, at least in part, to the use of specialized circuitry that intelligently prevents the inductor currents in one or more of the phases of the regulator from ramping below zero, thereby avoiding the extra recovery time that would otherwise be required on the rising edge during a fast positive load transient and improving voltage droop in the system.

### SUMMARY

Described herein are various devices and methods for operating improved DC-DC voltage regulators, in which the inductor currents in one or more phases are not allowed to ramp below zero.

One embodiment of the invention disclosed herein is a multi-phase switching power conversion circuit that may exhibit improved transient response, i.e., smaller transient voltage drop. The circuit has a number of phases coupled to an output node, wherein each of the phases has an inductor coupled to a power switch circuit. A controller is coupled to control the switching of the phases to yield a regulated voltage on the output node. One or more of the phases are deemed to be “designated” phases, in the sense that the controller is designated to use a zero crossing detector circuit to limit the inductor current to zero (or a designated value) for such phases, while the other, i.e., non-designated, phases are allowed to ramp down a negative current limit value. In practice, the zero crossing detector circuit may operate by measuring current through a respective inductor. It detects when the inductor current goes below OA. A standard practice in buck converters is to measure the high side FET current and then estimate the inductor sensing current. Other methods of determining zero current may also be employed, e.g., direct sensing from the inductor.

In one embodiment, the inductor of the designated phase (which, as described above, is a phase inductor that is controlled in accordance with the zero crossing detector for imposing inductor current limits) may be a “master phase” inductor that has higher inductance. As a result of the higher inductance, the master phase may also have a slower slew rate and lower saturation current than the one or more “slave phase” inductor(s) of the regulator, which uses a lower inductance coil.

In other embodiments, there may be different combinations of designated phases, e.g., a combination of a master phase and one or more slave phases, or simply one or more slave phases, which may have zero crossing detectors. In some embodiments, it may be preferred that the master inductor, which may have a slower response time (i.e., slower slew rate) than the slave phase inductor(s), utilizes a zero current detector and is clamped to Discontinuous Conduction Mode (DCM) operation (i.e., wherein the inductor is clamped to zero current)—due, at least in part, to the fact that the process of ramping up from NLIMIT to the positive current limit is faster for the slave inductors, and hence provides improved voltage droop.

In other embodiments, one or more phases may initially be chosen to be the designated phase or phases, and then, based on a particular operating mode, different phases may be selected to act as the designed phases over time. In other words, the selection of designated phases does not have to be strictly pre-programmed; it may instead be changed dynamically.

In other embodiments, the regulator may employ individual, programmable negative current limits for each phase, e.g., down to as low as 0 mA (i.e., DCM operation). In some embodiments, the master phase should be allowed DCM operation only (i.e., no negative current at all), whereas the slave phase inductors may be programmable down to as low as 0 mA, −500 mA, −750 mA, −1.5 A etc. This is described in greater detail with reference to FIG. 3C below. According to some embodiments, the regulator may programmable as to whether certain slave inductors will also be allowed DCM operation.

In still other embodiments, a throttling signal may be used to limit the load transients experienced at the negative current limit (i.e., the NLIMIT). If the one or more of the phases are programmed to have high negative current limits, it may be advantageous, according to some embodiments, to utilize a throttle to send a signal to a central processing unit (CPU) requesting the CPU to limit its frequency in the next load step, so long as the one or more phases are still within the negative current limit window. In some embodiments, the throttle may be enabled when all phases (or two or more phases) reach NLIMIT within the same time window—or even simultaneously—so as to limit the risk of over-throttling the CPU. An example implementation is described in greater detail with reference to FIG. 4 below.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above Summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness, a given figure may be used to illustrate the features of more than one embodiment of the invention, or more than one species of the invention, and not all elements in the figure may be required for a given embodiment or species.

FIG. 1 is a block diagram of a switching power conversion circuit.

FIG. 2 is a block diagram of a multiphase controller using a zero crossing detector for a switching power conversion circuit.

FIG. 3A illustrates waveforms of inductor current, load current, and output voltage for a multiphase switching power conversion circuit not employing zero crossing detection, in addition to a multiphase switching power conversion circuit employing zero crossing detection for a slave phase inductor.

FIG. 3B illustrates waveforms of inductor current, load current, and output voltage for a multiphase switching power conversion circuit not employing zero crossing detection, in addition to a multiphase switching power conversion circuit employing zero crossing detection for a master phase inductor.

FIG. 4 illustrates waveforms of inductor current and throttler signals for a multiphase switching power conversion circuit having one master phase inductor and two slave phase inductors.

FIG. 5 is a block diagram of an example portable device in which a switching power conversion circuit can be used.

### DETAILED DESCRIPTION

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one implementation of the invention, and multiple references to “one embodiment” or “an embodiment” should not be understood as necessarily all referring to the same embodiment.

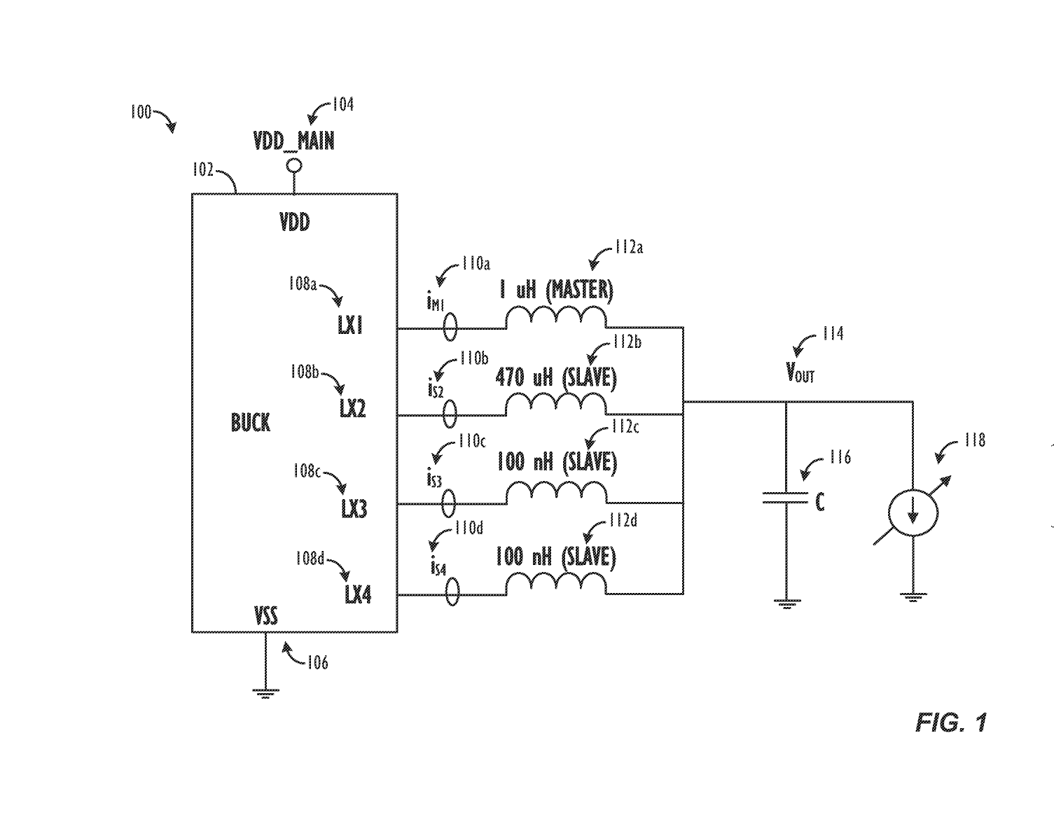

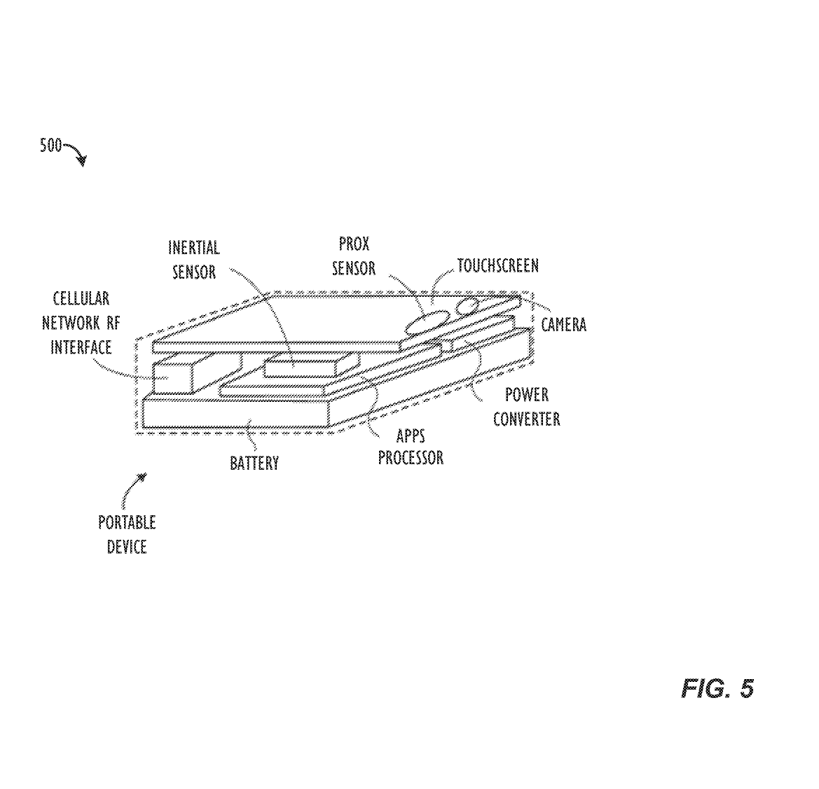

FIG. 1 is a block diagram of a switching power conversion circuit 100, in accordance with one or more embodiments of the invention. The conversion circuit produces a regulated output voltage, i.e., Vout 114, by converting power from an input port that, in this embodiment, is at a DC input voltage, VDD_MAIN 104. In one embodiment, the input voltage is obtained from a rechargeable battery or from an external power adapter when plugged in, as in a portable electronic device (see, e.g., FIG. 5). It should be noted, however, that the various embodiments of the invention described here could also be used with non-portable devices, including, for example, desktop computers and other consumer electronic devices that present demanding input voltage and load conditions upon a power converter.

The switching power conversion circuit shown has a number of phases, in this case, four phases labeled LX1-LX4 and numbered 108a-108d, where each phase has an inductor, e.g., master inductor (112a) or slave inductor (112b-112d), that is coupled to a power switch circuit (not shown) of buck converter 102 at one end and to an output node, Vout 114, at another end. Each power switch may have a number of power stage transistor switch circuits. The phases may be independently coupled to feed their currents to the output node 114 having voltage Vout as shown, where the output node may also have a filter or ripple control capacitor, C 116. A load 118 is connected to the output node 114, where this load can be viewed as a variable current sink.

Power conversion circuit 100 may also comprise a controller, also referred to herein as a switch mode controller, which may operate in accordance with any one of different switch mode power converter topologies, although, in this embodiment, the controller, power switch circuits, and inductors 112a-112d are configured in accordance with a buck converter topology 102. Alternatives include a boost converter topology, where Vout is regulated to a higher voltage than Vin.

The buck converter is an example of a step-down converter, in which the output voltage, Vout, is lower than Vin, and wherein both the input and output voltages are DC voltages. The controller comprises phase control logic for controlling both the master and slave phases that generate the appropriate transistor pulse control signals at its phase control outputs (e.g., a set of one or more control signals for each phase). These will have the appropriate amplitude swing and timing, and are applied to control the power switches independently in each phase, so as to switch them on and off according to a closed loop control algorithm that obtains feedback of the output voltage, Vout. Regulation of Vout is thus achieved under both varying Vin and varying load. The inductor in each phase (e.g., 112a-112d) is used as an energy storage element that conducts an inductor current (e.g., 110a-110d, respectively) for that phase, which is being switched to rise or to fall with time, by the associated power switch circuit. The output capacitor C 116 acts as a further energy storage element that helps smooth out a switching-induced ripple that is inherent in Vout. The load (or load current) is drawn by circuitry that may include one or more subsystems, for example those shown in FIG. 5.

The controller may be part of a larger power management circuit that may include the power switch circuits on-chip with analog sensing and processing circuits, as well as digital timing and data processing circuitry of the controller. Of course, other power management hardware not shown in FIG. 1, such as a data communications interface for communicating with an off chip processor, may also be included.

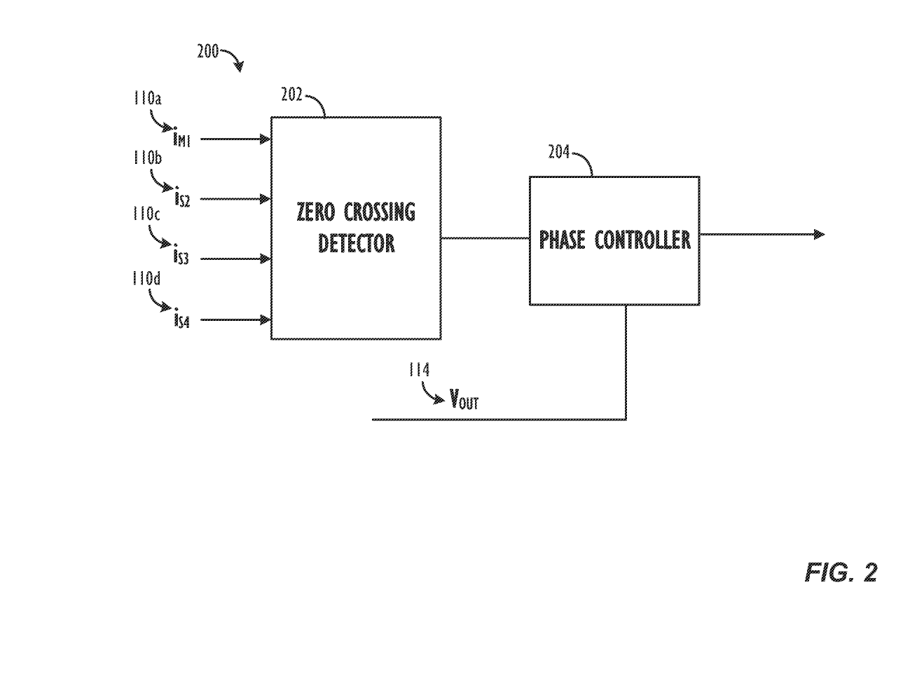

Turning now to FIG. 2, a block diagram 200 of a phase controller 204 using a zero crossing detector 202 for a multiphase switching power conversion circuit is shown. Phase controller 204 may comprise supplemental logic implementation to a standard multiphase regulator controller that is, e.g., part of a regulator such as regulator 102. The phase controller 204 may be coupled to zero crossing detector 202 to control the switching of one or more of the phases—in this example, the currents for each of four phases are shown—in order to yield a regulated voltage Vout on the output node 114. The zero crossing detector 202 may look for zero crossings of any or all of the currents 110a-110d, and may provide information to phase controller 204 regarding which currents have had zero crossings. Phase controller 204 may then select which (if any) of the phases to clamp to zero current, e.g., based on programming instructions, as described in greater detail below. According to some embodiments, the phase controller 204 may turn on each of the slave phases 112b-112d, causing a current to be drawn through 110b-110d, respectively, when Vout 114 falls below a predetermined voltage threshold, Vset, also referred to herein as the “panic threshold.”

As mentioned above, negative current limits may be employed on all the phases because the regulator needs the voltage to ramp down by sinking current from the output capacitor, but the negative current limits may be designed intelligently to improve performance. Thus, according to some embodiments disclosed herein, the zero crossing detector 202 and phase controller 204 may be employed to: 1.) prevent the master phase from going below 0 mA; 2.) prevent one or more slave phases from going below 0 mA; or 3.) prevent the master phase and one or more (but not all) of the slave phases from going below 0 mA. As will be explained in detail below, clamping certain of the inductor phases to 0 mA during load transients will improve performance of the circuit. Zero crossing detector 202 and phase controller 204 may monitor all inductor currents, or instead may monitor only the designated phases for zero crossings. According to some embodiments, the timing of when a first phase crosses zero may be used to alert zero crossing detector 202 and phase controller 204 that one or more other phases may be soon to cross zero, thus allowing the controller the possibility of preemptively clamping one or more of the phases that are soon to cross zero.

According to some preferred embodiments, the zero current limit will be applied to the master phase because the master phase is typically slower and would therefore cause extra delays when ramping up to meet a load step. In other embodiments, the master phase and one or more of the slave phases may be clamped to 0 mA, thus allowing all of the current to be sunk in the one or more other slave phase inductors, preferably having fast slew rates, which are not clamped to 0 mA.

In still other embodiments, one or more of the phase inductors could be employed dynamically, based on the system's timing requirements. Ideally, the voltage should drop in the most efficient way possible, whereby the speed at which an inductor can sink current determines the system's efficiency. The selection of sizes and combinations of inductors for the master and slave phases (and the sequence by which they are turned on and/or clamped to zero current) may be based on a tradeoff between efficiency and transient tolerance. For example, inductors with very small inductances (e.g., on the order of Nanohenries) are very fast, but, at low load levels, would need to be switched at very high frequencies, which would be inefficient. Inductors with larger inductances (e.g., on the order of Microhenries), while they do not need to be switched at as high of frequencies, are much slower, which could lead to additional delays in meeting load steps.

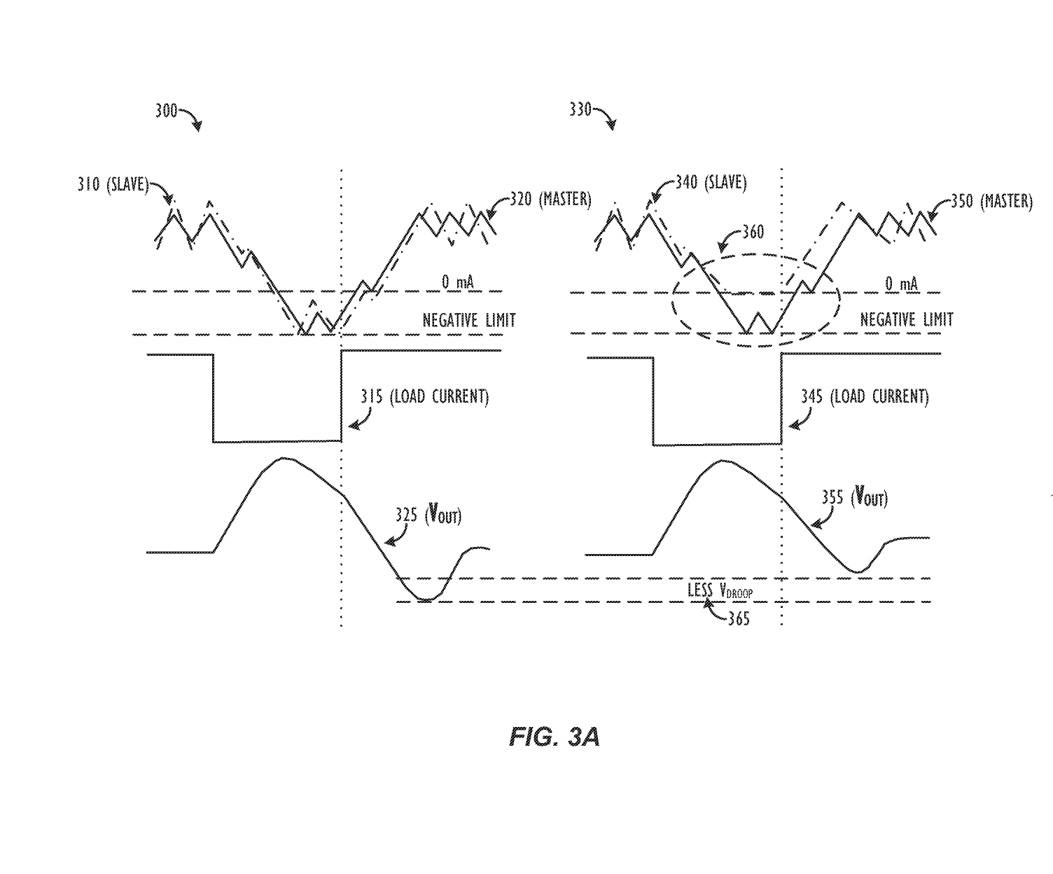

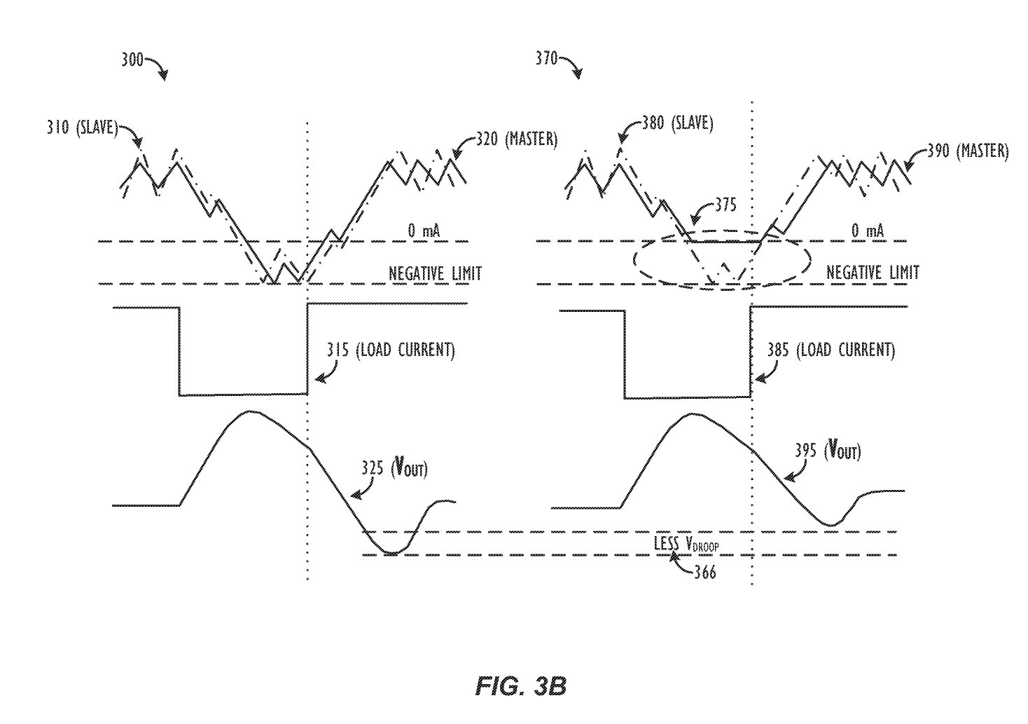

Turning now to the left-hand side of FIG. 3A, waveforms 300 for inductor current (310/320), load current (315), and output voltage (325) for a multiphase switching power conversion circuit not employing zero crossing detection are shown in graph form. As shown, dashed line waveform 310 reflects the inductor current through an exemplary slave phase inductor, whereas solid line waveform 320 reflects the inductor current through an exemplary master phase inductor. In the example of FIG. 3A, both inductor phases are allowed to reach their negative current limit (“NLIMIT”), as shown by the horizontal “Negative Limit” dashed line below the 0 mA dashed line. As described above, if the load current 315 undergoes a “load step” operation when the negative current limit is hit on one or more of the inductor phases, it may cause a significant “droop” in the output voltage 325 as the inductor currents ramp back up to zero and then to their maximum current values.

Turning now to the right-hand side of FIG. 3A, waveforms 330 for inductor current (340/350), load current (345), and output voltage (355) for a multiphase switching power conversion circuit employing zero crossing detection for a slave phase inductor are shown in graph form. As shown, dashed line waveform 340 reflects the inductor current through an exemplary slave phase inductor, whereas solid line waveform 350 reflects the inductor current through an exemplary master phase inductor. In the example of FIG. 3B, only the master phase inductor is allowed to reach the negative current limit (“NLIMIT”), as shown inside the dashed line circle 360 by only the solid master phase inductor line 350 reaching down to the horizontal “Negative Limit” dashed line below the 0 mA dashed line. As described above, if the load current 345 undergoes a “load step” operation when the negative current limit is hit on one or more of the inductor phases, it may be beneficial to have one or more of the slave phase inductors held at 0 mA, so that they more quickly ramp up to meet the step load condition. As shown in the output voltage graph 355, there is less voltage droop (shown by the difference, 365) in FIG. 3B than in FIG. 3A, wherein all the inductor phases were allowed to reach their negative current limits. In some embodiments, the amount of Vdroop saved by clamping one or more phases to zero current may be on the order of 10-20 mV. This demonstrates some of the improvements gained by the use of zero crossing detection on the slave phase inductor.

Turning now to the right-hand side of FIG. 3B, waveforms 370 for inductor current (380/390), load current (385), and output voltage (395) for a multiphase switching power conversion circuit employing zero crossing detection for a master phase inductor are shown in graph form. Waveforms 370 are shown side-by-side with a reproduced copy of waveforms 300 from FIG. 3A so that the comparative voltage droop between waveform 325 and waveform 395 may also be appreciated, just as it was between waveform 325 and waveform 355 on the previous drawing sheet. As shown, dashed line waveform 380 reflects the inductor current through an exemplary slave phase inductor, whereas solid line waveform 390 reflects the inductor current through an exemplary master phase inductor. In the example of FIG. 3B, only the slave phase inductor is allowed to reach the negative current limit (“NLIMIT”), as shown inside the dashed line circle 375 by only the dashed slave phase inductor line 380 reaching down to the horizontal “Negative Limit” dashed line below the 0 mA dashed line. As described above, if the load current 385 undergoes a “load step” operation when the negative current limit is hit on one or more of the inductor phases, it may be beneficial to have one or more of the master phase inductors held at 0 mA, since they are typically larger and slower than slave phase inductors, and thus would take more time to ramp up from the negative current limit to meet the step load condition than would a smaller, faster slave phase inductor with a faster slew rate. As shown in the output voltage graph 395, there is less voltage droop (shown by the difference, 366) in FIG. 3B than in FIG. 3A, wherein all the inductor phases were allowed to reach their negative current limits. This demonstrates some of the improvements gained by the use of zero crossing detection on the master phase inductor. As mentioned above, in still further embodiments, the master phase inductors—as well as one or more of the slave phase inductors—may be held to 0 mA by the zero crossing detector circuit 202, so long as at least one of the slave phase inductors is allowed to reach the negative current limit.

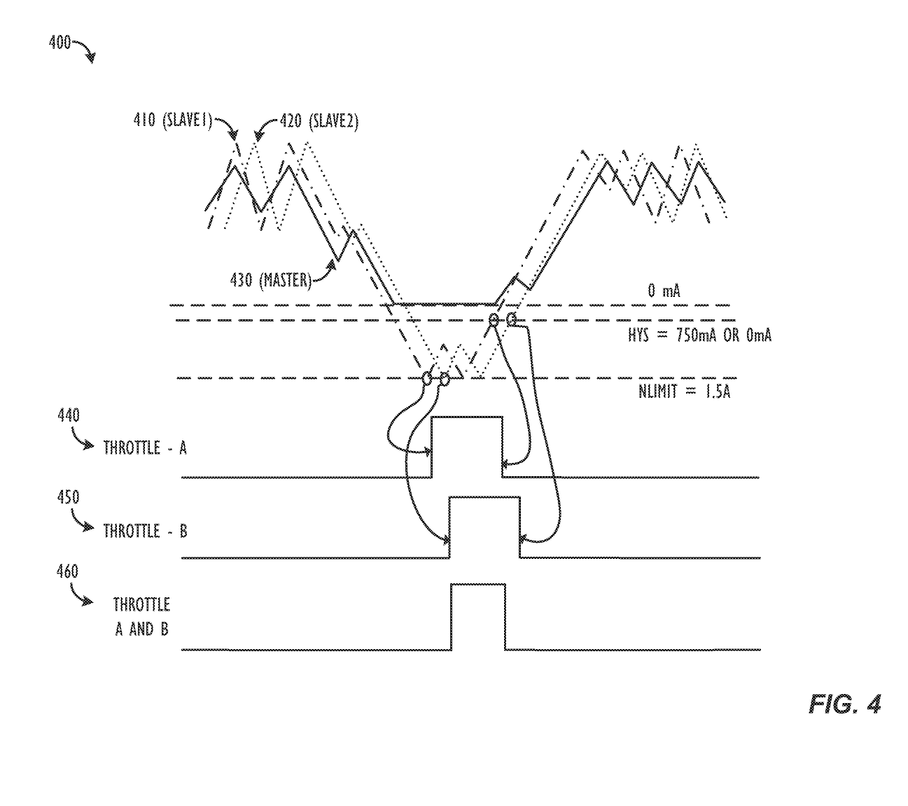

Turning now to FIG. 4, waveforms 400 for inductor current (410/420/430) and throttler signals (440/450/460) for a multiphase switching power conversion circuit having one master phase inductor and two slave phase inductors are shown in graph form. As shown, dashed line waveform 410 and dotted line wave form 420 reflect the inductor current through two exemplary slave phase inductors, slave 1 and slave 2, respectively, whereas solid line waveform 430 reflects the inductor current through an exemplary master phase inductor. In the example of FIG. 4, only the slave phase inductors are allowed to reach the negative current limit (“NLIMIT”), as shown by only the slave phase inductor lines 410 and 420 reaching down to the horizontal “Negative Limit” dashed line, labeled as −1.5 A.

As mentioned above, if one or more of the phases are programmed to have high negative current limits, it may be advantageous, according to some embodiments, to utilize a throttle to send a signal to the CPU requesting the CPU to limit its frequency in the next load step, so long as the one or more phases are still within the negative current limit window. As shown in FIG. 4, throttle signal A (440) may go high during the window of time that the inductor current through slave phase inductor, slave 1 (410), is between the negative current limit (“NLIMIT”) and 0 mA (or some hysteresis value below 0 mA, e.g., −750 mA). As is also shown in FIG. 4, throttle signal B (450) may go high during the window of time that the inductor current through slave phase inductor, slave 2 (420), is between the negative current limit (“NLIMIT”) and 0 mA (or some hysteresis value below 0 mA, e.g., −750 mA). As shown by throttle signal “A AND B” (460), in some embodiments, the throttle may be enabled only when all phases (e.g., two or more phases) reach NLIMIT simultaneously (or within the same time window), so as to limit unnecessarily over-throttling the processor unnecessarily and thus losing speed.

Turning now to FIG. 5, an example portable electronic device 500, in which an embodiment of the invention may be implemented is shown. While some of the benefits of the invention are more apparent in such power consumption-sensitive devices, due to the tighter tolerance on transient voltage drop of a power supply voltage, an embodiment of the invention may also find use in non-portable electronic devices, such as desktop computers. The portable device shown has an external or outer housing (shown in dotted lines) in which a number of its constituent sub-systems may be installed, including, in this example, an applications processor, a cellular network RF interface, a digital camera, a touch screen, a proximity sensor and an inertial sensor. These sub-systems may be found in a typical smart phone or tablet computer that also contains a rechargeable battery to power all of the sub-systems shown. In other portable devices, some of these sub-systems may, of course, be absent. One or more of such sub-systems may be connected to be powered by an output node of a power conversion circuit as described above.

The power conversion circuit may be one or more DC-DC voltage regulating down converters (or boost converters), that are connected in parallel to the same output node and are also installed in the housing of the portable device, in order to provide a regulated DC supply voltage to one or more connected sub-systems. An embodiment of the invention automatically limits the inductor current of one or more designated phases of the power conversion circuit to zero, e.g., via the use of a zero crossing detection circuit, so as to help reduce transient voltage drop on the output node that may be caused by a sudden and significant increase in activity of one or more of the connected subsystems.

### Examples

The following examples pertain to additional embodiments.

Example 1 is a power conversion apparatus comprising: a multi-phase power converter having a master phase coupled to a load by a master inductor and one or more slave phases coupled to the load by one or more corresponding slave inductors; and control logic operatively coupled to the multi-phase power converter configured to monitor an output voltage supplied to the load and current through each of the one or more slave inductors, the control logic being further configured to operate the multi-phase power converter so as to prevent negative current flow through one or more designated phases of the power converter.

Example 2 includes the subject matter of example 1, wherein the one or more designated phases comprise the master phase.

Example 3 includes the subject matter of example 1, wherein the one or more designated phases comprise the one or more slave phases.

Example 4 includes the subject matter of example 1, wherein the one or more designated phases comprise the master phase and at least one of the one or more slave phases.

Example 5 includes the subject matter of example 1, wherein the control logic further comprises a zero crossing detector.

Example 6 includes the subject matter of example 1, wherein the control logic is further configured to prevent negative current flow through the one or more designated phases of the power converter in response to a decrease in current required by the load.

Example 7 includes the subject matter of example 1, wherein a first one of the one or more slave inductors has an inductance that is different from a second one of the one or more slave inductors.

Example 8 includes the subject matter of example 1, wherein a first one of the one or more slave inductors has a slew rate that is faster than a slew rate of the master inductor.

Example 9 is a battery powered portable electronic device comprising: a housing having installed therein: a processor having a power supply input; a battery; and a DC-DC multi-phase switching power converter having: an input coupled to the battery; an output coupled to the power supply input of the processor; a plurality of phases, of which at least one is a designated phase that is prevented from having a negative current; and a controller having a zero crossing detector for the designated phase, wherein the controller prevents the inductor current for the designated phase from being negative.

Example 10 includes the subject matter of example 9, wherein the designated phase comprises a master phase of the power converter.

Example 11 includes the subject matter of example 9, wherein the designated phase comprises a slave phase of the power converter.

Example 12 includes the subject matter of example 9, wherein the designated phases comprise a master phase and at least one slave phase.

Example 13 includes the subject matter of example 9, wherein the zero crossing detector is configured to monitor each of the plurality of phases.

Example 14 includes the subject matter of example 9, wherein the controller prevents the inductor current for the designated phase from being negative in response to a decrease in current required by the load.

Example 15 includes the subject matter of example 9, wherein the plurality of phases comprises one or more slave inductors and one master inductor.

Example 16 includes the subject matter of example 15, wherein a first one of the slave inductors has an inductance that is different from a second one of the one or more slave inductors.

Example 17 includes the subject matter of example 15, wherein a first one of the one or more slave inductors has a slew rate that is faster than a slew rate of the master inductor.

Example 18 includes the subject matter of example 15, wherein the master inductor has an inductance that is greater than each of the one or more slave inductors.

Example 19 is a method for providing a regulated voltage, comprising: performing switching control of a plurality of phase currents that are feeding an output node, while the output node exhibits a regulated voltage and one or more of the phase currents remains at or above zero amps; and activating a throttler mechanism when, simultaneously, two or more of the plurality of phase currents are at or within a predetermined threshold amount of their respective negative current limits.

Example 20 includes the subject matter of example 19, wherein the throttler mechanism is configured to, when activated, send a signal to a central processing unit (CPU) to cause the CPU to limit its frequency on a next load step.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., some of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled.

1. A power conversion apparatus comprising:
a multi-phase power converter having a master phase coupled to a load by a master inductor and one or more slave phases coupled to the load by one or more corresponding slave inductors; and
control logic operatively coupled to the multi-phase power converter configured to monitor an output voltage supplied to the load and current through each of the one or more slave inductors, the control logic being further configured to operate the multi-phase power converter so as to prevent negative current flow through one or more designated phases of the multi-phase power converter.

2. The power conversion apparatus of claim 1, wherein the one or more designated phases comprise the master phase.

3. The power conversion apparatus of claim 1, wherein the one or more designated phases comprise the one or more slave phases.

4. The power conversion apparatus of claim 1, wherein the one or more designated phases comprise the master phase and at least one of the one or more slave phases.

5. The power conversion apparatus of claim 1, wherein the control logic further comprises a zero crossing detector.

6. The power conversion apparatus of claim 1, wherein the control logic is further configured to prevent the negative current flow through the one or more designated phases of the multi-phase power converter in response to a decrease in current required by the load.

7. The power conversion apparatus of claim 1, wherein a first one of the one or more slave inductors has an inductance that is different from a second one of the one or more slave inductors.

8. The power conversion apparatus of claim 1, wherein a first one of the one or more slave inductors has a slew rate that is faster than a slew rate of the master inductor.

9. A battery powered portable electronic device comprising:
a housing having installed therein:
a processor having a power supply input;
a battery; and
a DC-DC multi-phase switching power converter having:
an input coupled to the battery;
an output coupled to the power supply input of the processor;
a plurality of phases, of which at least one is a designated phase that is prevented from having a negative current; and
a controller having a zero crossing detector for the designated phase, wherein the controller prevents inductor current for the designated phase from being negative.

10. The device of claim 9, wherein the designated phase comprises a master phase of the multi-phase power converter.

11. The device of claim 9, wherein the designated phase comprises a slave phase of the multi-phase power converter.

12. The device of claim 9, wherein
the plurality of phases comprises one or more designated phases;
the one or more designated phases comprise a master phase and at least one slave phase; and
the controller prevents inductor currents for the one or more designated phases from being negative.

13. The device of claim 9, wherein the zero crossing detector is configured to monitor each of the plurality of phases.

14. The device of claim 9, wherein the controller prevents the inductor current for the designated phase from being negative in response to a decrease in current required by the load.

15. The device of claim 9, wherein the plurality of phases comprises one or more slave inductors and one master inductor.

16. The device of claim 15, wherein a first one of the slave inductors has an inductance that is different from a second one of the one or more slave inductors.

17. The device of claim 15, wherein a first one of the one or more slave inductors has a slew rate that is faster than a slew rate of the master inductor.

18. The device of claim 15, wherein the master inductor has an inductance that is greater than each of the one or more slave inductors.

19. A method for providing a regulated voltage, comprising:
performing switching control of a plurality of phase currents that are feeding an output node, while the output node exhibits a regulated voltage and one or more of the plurality of phase currents remains at or above zero amps; and
activating a throttler mechanism when, simultaneously, two or more of the plurality of phase currents are at or within a predetermined threshold amount of respective negative current limits of the two or more of the plurality of phase currents.

20. The method of claim 19, wherein the throttler mechanism is configured to, when activated, send a signal to a central processing unit (CPU) to cause the CPU to limit the CPU's frequency on a next load step.
